(19) United States
(12) Patent Application Publication
(10) Pub. No.: US 2009/0104861 A1
(43) Pub. Date: Apr. 23, 2009

(54) HANDLE ASSEMBLY FOR A POWER TOOL

(75) Inventors: BENJAMIN LUKE VAN DER LINDE, Victoria (AU); David Leigh Scrimshaw, Victoria (AU); Paul Davies, Victoria (AU); Paul Miller, Upwey (AU); Paul Francis Connor, Victoria (AU)

Correspondence Address: AKERMAN SENTERFITT, P.O. BOX 3188, WEST PALM BEACH, FL, 33402-3188, US

(73) Assignee: DEMAIN TECHNOLOGY PTY LTD., Victoria (AU)

(21) Appl. No.: 12/258,894

(22) Filed: Oct. 27, 2008

Related U.S. Application Data
(63) Continuation-in-part of application No. PCT/AU2007/000537, filed on Apr. 26, 2007.

(30) Foreign Application Priority Data
Apr. 26, 2006 (AU) 2006902154

(51) Int. Cl. B24B 27/08; B23B 45/00

(52) U.S. Cl. 451/344; 173/170

(57) ABSTRACT

A handle assembly for a power tool, such as an angle grinder, including first and second handle portions for gripping the power tool, the first handle portion extending substantially transverse to the second handle portion. The handle assembly also having a trigger including an elongate portion associated with the first handle portion and a flange portion associated with the second handle portion and a switch for operating the power tool actuated by movement of either the elongate or flange portion of the trigger relative to the first or second handle portions respectively.

### CROSS REFERENCE TO RELATED APPLICATIONS

This application is a continuation-in-part application of PCT Application No. PCT/AU2007/000537, filed Apr. 26, 2007, which claims priority to AU 2006902154, filed Apr. 26, 2006, both of which are incorporated herein by reference in their entirety.

### BRIEF DESCRIPTION OF THE INVENTION

The present invention relates to power hand tools and more particularly to a handle assembly of the type used for holding, activating and deactivating a power hand tool. The handle assembly of the present invention is particularly suitable for use in relation to a hand held power angle grinder and is discussed below in this context.

### BACKGROUND OF THE INVENTION

Hand held power angle grinders have an electric motor driving a driven member that grips a working element, such as an abrasive disc, for performing work on a workpiece. There are a myriad of different discs that are used for various materials and tasks, such as cutting discs, buffing pads and saws, each of which can be renewed when worn or switched when required. The angle grinder has large bearings to counter side forces generated during cutting, unlike a power drill where the force is axial. Used widely in Engineering, in particular metalworking and construction, as well as in emergency rescues, hand held power angle grinders can be very dangerous due to the high rpm involved and the sparks that fly off as they cut. Safety equipment is usually worn while using these power tools to avoid injury.

Hand held power angle grinders can have an electric motor, a pneumatic drive or an internal combustion motor for driving the driven member in a circular motion that in turn causes the working element to rotate. In each case a hand held power angle grinder will include a switch assembly that is operable by the hand of a user for activating the motor when the grinder is in use. Grinders that have electric motors will usually also have an electric power lead having a plug at one end that is adapted to be received in a power socket while the other end enters the grinder housing. The power lead connects to a switch assembly within the grinder housing. Alternatively, grinders may have an on-board energy storage device, such as a battery, connected to the switch assembly rather than an electric power lead connected to a power socket. The switch assembly is operable by hand to complete an electrical circuit with the grinder's electric motor. Current flows through the completed circuit and through the motor to drive the driven member and rotate the working element. The switch assembly is also operable by hand to break the circuit and cut the flow of current to the motor when the grinder is not in use.

Existing switch assemblies that are incorporated into hand held power angle grinders include an elongate trigger that is operable by hand to actuate a switch mechanism between an off position where the circuit is broken and no current flows to the motor and an on position where the circuit is completed and current flows through the motor. The elongate trigger is generally attached to the housing of a grinder and oriented lengthwise with and protruding from the housing. The trigger is designed so that a user's hand wraps around the housing and the fingers engage the elongate trigger and squeeze the trigger into the housing.

Existing switch assemblies include, as a safety feature, two separate pivot points that enable the elongate trigger to move through two travel paths so that the grinder cannot be inadvertently activated if the grinder is picked up or dropped. In fact, in some countries, such a feature is mandated by law. The first path of movement is longitudinal such that when a user operates the trigger by hand the trigger is moved firstly through a longitudinal motion that is usually lengthwise along the grinder housing. After the trigger has moved through the first path it can then move through the second path of motion. The second path is a pivoting motion. The pivoting motion involves the trigger pivoting about a point of attachment of the trigger with the housing of the grinder. The point of attachment on the trigger, which is also the point about which the trigger pivots, is located at an end of the trigger in the direction from where the trigger moved longitudinally in the first path of motion. Thus, the leading end of the trigger in the direction of longitudinal travel is also the end that pivots in an arc in the second path of motion. This end is squeezed by hand into the housing in the second path of motion. This causes a protrusion on the lever to engage the switch and place it in the on position where current flows to the motor.

To enable a user to move the trigger through the two paths of motion the trigger has a flange at the opposite end to the point of attachment of the trigger about which it pivots. The user's hand grips around the elongate portion of the trigger such that the user's hand can abut against the flange and slide the trigger longitudinally through the first path and then pivot the trigger about the pivot point through the second path by squeezing the trigger inwardly towards the grinder housing. The switch assembly includes biasing means that bias the trigger into a resting position that corresponds to the position of the trigger before it is moved through the first path of motion. Thus when the trigger is released, the protrusion on the trigger disengages the switch so that the switch reverts to the off position where current does not flow to the motor.

Existing switch assemblies such as those mentioned above are used in relation to hand held power angle grinders. Nonetheless, there are problems that arise through the use of these switch assemblies. One problem is that the trigger, which generally protrudes from the grinder housing, can be damaged if the grinder is dropped. Another problem is that the user's hand must grip the housing which is often large in diameter relative to the size of a user's hand. As such, a user can not reach around the housing to adequately grip the grinder while still activating the switch assembly, and in turn the grinder, by moving the trigger through the two paths of motion. Having an adequate grip is imperative for hand held power tools such as grinders in order to ensure that the user can accurately manipulate the grinder and the working element on the workpiece. Yet another drawback with existing switch assemblies is that they can only be operated with one hand location. That is to say existing switch assemblies do not enable a user to place their hand on the grinder at different points and in different orientations to impart different forces on the grinder in different directions depending on the task that is being performed with the grinder while enabling the user to activate the switch assembly from each hand placement.

A hand held power angle grinder is one form of power tool that may incorporate the present invention. It will be convenient to hereinafter describe the invention with particular reference to held power angle grinders, but it is to be understood that the invention has broader application. It will also be convenient to hereinafter describe the invention with particular reference to portable power tools, whereas the invention is applicable to power tools of a non-portable nature.

### DETAILED DESCRIPTION OF THE PREFERRED EMBODIMENT

Accordingly, in a first aspect the present invention is directed towards providing a handle assembly for a hand held power tool, the assembly including:

first and second handle portions for gripping the power tool, the first handle portion extending substantially transverse to the second handle portion;

a trigger including an elongate portion associated with the first handle portion and a flange portion associated with the second handle portion; and

a switch for operating the power tool actuated by movement of either the elongate portion or the flange portion relative to the first or second handle portions respectively.

An advantage of the invention over existing gripping means and switch assemblies for holding and operating hand held power tools is that a user can grip and operate a device incorporating the invention more easily, more securely, with more control and with less discomfort. Another advantage is that a user need not grip the housing of such a device in order to operate a switch for turning the device on and off. Yet another advantage of a hand held power tool incorporating the present invention is that the user has a choice of handles with which to hold the device and move the trigger to actuate the switch and operate the tool. This enables a user to place their hand on the handle of a device incorporating the invention, such as a grinder, at different points and in different orientations to impart different forces on the grinder in different directions depending on the necessities of the task that being performed by the user.

Preferably, one end of the elongate portion is movably mounted to the first handle portion and an opposite end of the elongate portion is pivotally interconnected with the flange portion.

In another form, one end of the elongate portion is movably mounted to the first handle portion and an opposite end of the elongate portion is integrally formed with the flange portion.

In yet another form, the elongate portion and the flange portion are movable independently of each other.

In a preferred form, one end of the elongate portion is pivotally mounted to the first handle portion such that the elongate portion and the flange portion of the trigger pivot in an arc of motion to actuate the switch.

The handle assembly preferably includes a guard that is integral with one or more of the handle portions and is configured to form, together with the handle portions, a continuous loop around the trigger. This embodiment is advantageous in that it prevents the trigger from suffering damage if the power tool is dropped. It also reduces the likelihood of inadvertent operation of the trigger.

In one form the handle assembly includes an electric power lead for supplying electric current from a power source to the power tool. The power lead has two ends, one end is connectable to the power source and the other end is coupled to the guard. Having the power lead coupled to the guard is advantageous over existing arrangements where the power lead is coupled to the handle assembly nearer the switch thereby interfering with gripping the handle near the switch. Such interference from the power lead is avoided in this embodiment of the invention.

In another form, the switch has two parts, one part of the switch is integral with the elongate portion of the trigger and the other part of the switch is integral with the first handle portion such that movement of the trigger includes moving the elongate portion of the trigger towards the first handle portion for actuating the switch by engaging the two parts of the switch together.

Preferably, the trigger is attached to the first and second handle portions such that movement of the trigger to actuate the switch to operate the power tool involves sliding the trigger substantially longitudinally towards the second handle portion. This embodiment is advantageous in that it provides a means for avoiding inadvertent engagement of the switch parts and operation of the power tool.

In a preferred form, the invention further includes biasing means for biasing the trigger relative to the first and second handles to a default position in which the switch does not operate the power tool. This provides a resting state of the handle assembly in which power is not being supplied to the power tool such that the power tool is deactivated.

In yet another preferred form the invention may include a releasable trigger lock for releasably locking the trigger relative to the first and second handles in a position in which the switch operates the power tool. An advantage of this embodiment is that the user can activate the power tool by initially operating the trigger by hand and then, by locking the trigger, proceed to use the power tool for extended periods without having to retain the trigger in the operable position by hand.

In one form, the handle assembly of the present invention is pivotally mountable to the hand held power tool. In this form the handle assembly may pivot between various orientations relative to the hand held power tool. This form of the invention enables a user operating the power tool to adjust the handle assembly to a desired orientation that offers a secure and comfortable grip for the user with no discomfort or lack of control when the handle assembly is in any desired orientation. In various forms, the handle assembly may be pivotable to relative to an axis of the power tool through 360 degrees The assembly may be pivotable between 0 and 180 degrees or 0 and 90 degrees Preferably, the invention includes a means for retaining the handle assembly in the desired orientation and for releasing the handle assembly to pivot to another desired orientation. In one form, the pivotal mounting of the handle assembly to the power tool allows the handle assembly to rotate relative to the power tool.

Preferably the handle assembly of the present invention is for use in relation to a hand held power angle grinder. In one form, the assembly further includes a soft start control module for controlling power to the power tool. In another form, the assembly includes an overload protection device.

In another form, the handle assembly includes a trigger release mechanism which selectively enables movement of the trigger relative to the first or second handle portions. In one form, the trigger release mechanism includes a trigger release button which is mounted to the trigger and in a first position prevents relative movement of the trigger relative to the first or second handle portions and in a second position enables the trigger to move relative to the first or second handle portions. In another form, the trigger release button is normally in the first position and can be depressed by a user to the second position.

### BRIEF DESCRIPTION OF THE DRAWINGS

The present invention will now be described with reference to the figures of the accompanying drawings, which illustrate particular preferred embodiments of the present invention, wherein:

FIG. 1 is a side view of a preferred embodiment of the handle assembly of the present invention mounted to a power tool, which in this case is a hand held power angle grinder, the handle assembly including a trigger having an elongate portion associated with a first handle portion and a flange portion associated with a second handle portion.

FIG. 2 is a perspective view of the handle assembly and power tool of FIG. 1.

FIG. 3 is side view of the handle assembly and power tool of FIG. 1 illustrating some internal features of the handle assembly.

FIG. 4 is a perspective view of the handle assembly and power tool of FIG. 1 illustrating some internal features of the handle assembly.

FIG. 5 is another perspective view of the handle and switch assembly and power tool of FIG. 1 illustrating some internal features of the handle assembly.

FIG. 6 is side view of the handle assembly of FIG. 1 illustrating in more detail some internal features of the handle assembly.

FIG. 7 is a side view of another preferred embodiment of the handle assembly of the present invention mounted to a hand held power angle grinder in which the handle assembly features an arrangement of the trigger in which the elongate portion and the flange portion are pivotally interconnected and are in a default position in which the grinder is not activated.

FIG. 8 is a side view of the handle assembly of FIG. 7 in which the trigger is in a position for activating the grinder.

FIG. 9 is a perspective view of the trigger of the handle of FIG. 7 in which the elongate portion and the flange portion are pivotally interconnected and the elongate portion of the trigger having an electrode receiver that receives an electrode mounted to a switch.

FIG. 10 is a perspective view of the flange portion and the switch of FIG. 9 showing a projection from the flange portion abutting against a projection from the switch whereby the flange portion pivots about the abutting surfaces of the projections.

FIG. 11 is a perspective view of another preferred embodiment of the handle assembly of the present invention which is suitable for mounting to a power tool the handle assembly including a trigger having an elongate portion associated with a first handle portion and a flange portion associated with a second handle portion and a trigger release mechanism which includes a trigger release button.

FIG. 12 is a side view of the handle assembly embodiment of FIG. 11 in which a portion of the handle has been removed to illustrate components of the trigger that are obscured by the handle in an assembled condition.

FIG. 13 is a side view of the handle assembly embodiment of FIG. 11 in which a portion of the handle and the trigger have been removed to illustrate components of the trigger release mechanism that are obscured by the handle and the trigger in an assembled condition.

### DETAILED DESCRIPTION OF THE DRAWINGS

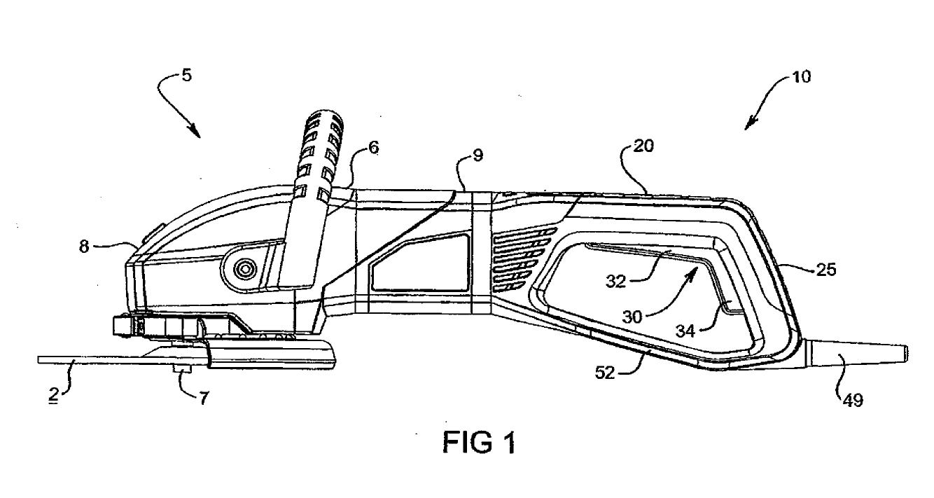

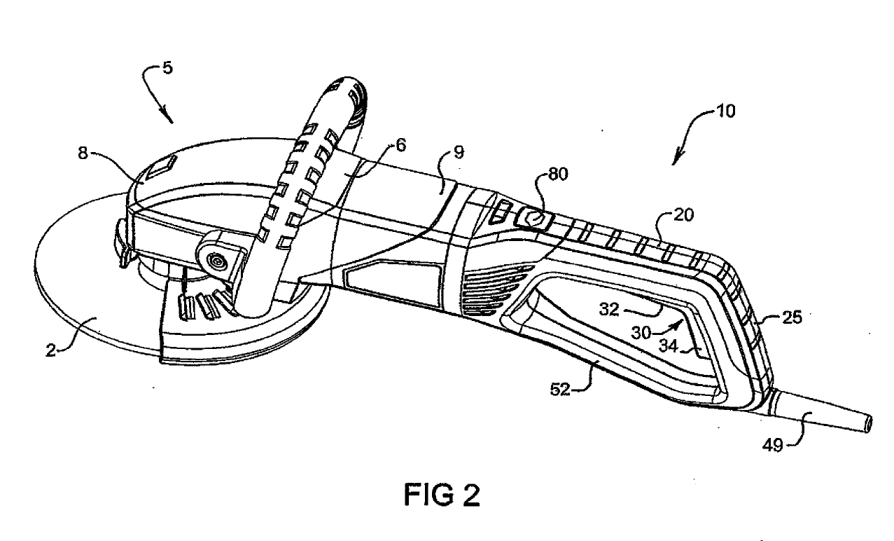

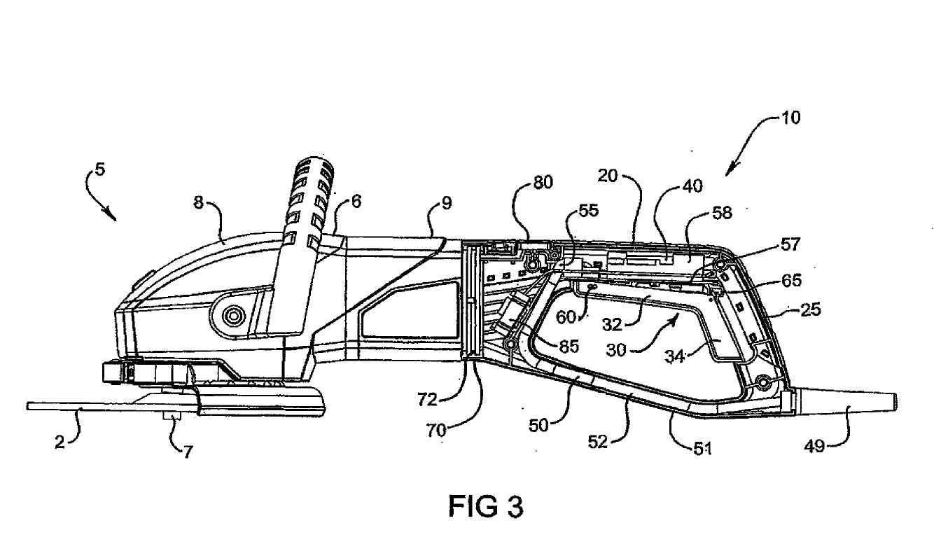

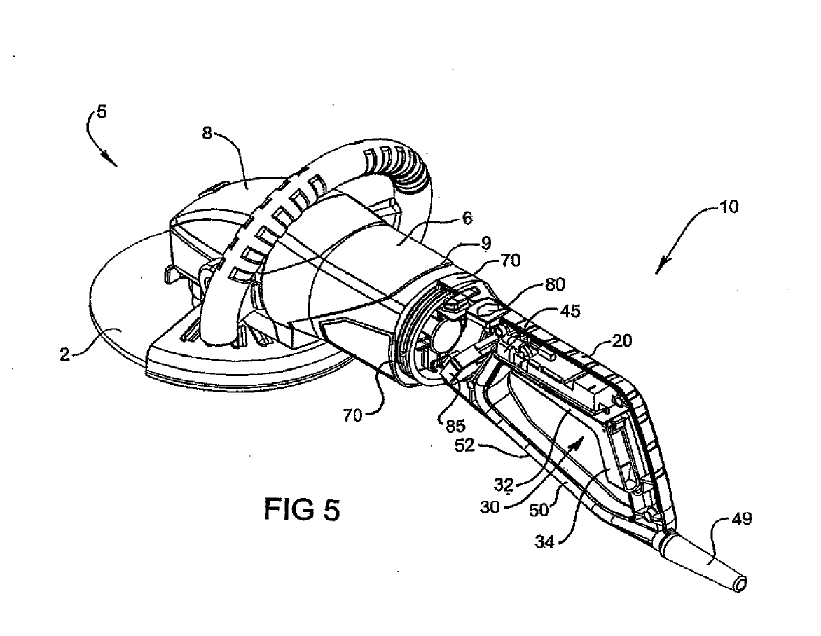

In FIGS. 1 to 6 there is shown a handle assembly 10 for mounting to a hand held power tool 5 in accordance with a preferred form of the invention. The handle assembly 10 includes a first handle portion 20 and a second handle portion 25. The first and second handle portions 20, 25 are integral and are mounted to the power tool 5. The handle portions 20, 25 are for gripping the power tool 5. The first handle portion 20 extends substantially transverse to the second handle portion 25. Also included is a trigger 30 mounted to the handle portions 20, 25. The trigger 30 is also coupled to a switch 40 for operating the power tool 5 by enabling the activation and deactivation of the power tool 5. The trigger 30 acts as a means by which a user can actuate the switch 40 to operate the power tool 5. The trigger 30 includes an elongate portion 32 associated with the first handle portion 20 and a flange portion 34 associated with the second handle portion 25. This enables a user, while gripping either handle portion 20, 25, to operate the trigger 30 and in turn actuate the switch 40 that operates the power tool 5.

Although the handle assembly 10 of the present invention is shown in FIGS. 1 to 6 as mounted to a hand held power tool 5 that is an angle grinder it is to be appreciated that, although the invention is particularly suited to this purpose, the invention may have wider application such as mounted to hand held power tools such as circular saws, compound miter saws, electric hand drills and drivers, rotary hammer drills, reciprocating and jig saws, sanders including finishing, orbital, random, delta and belt sanders, planers, routers. Nonetheless, for the sake of simplicity the invention is described herein in detail in the context of use in relation to a hand held power angle grinder 5 or “grinder” for short.

The grinder 5 as shown by FIG. 1 includes a body 6 with a driven member 7 located at a front end 8 of the body 6. The driven member 7 grips a working element 2 that in the illustration is a cutting disc 2. Other forms of working element 2 are possible such as a grinding disc. The first handle portion 20 extends longitudinally from the rear end 9 of the body 6 and has associated with it the elongate portion 32 of the trigger 30. The first handle portion 20 is integral with the second handle portion 25 and extends substantially transverse to the second handle portion 25. The first handle portion 20 is located proximally to the body 6 of the grinder 5 whereas the second handle portion 25 is located distally to the body 6 of the grinder 5. Associated with the second handle portion 25 is the flange portion 34 of the trigger 30 that is integral with the elongate portion 32 of the trigger 30. The elongate portion 32 of the trigger 30 is located proximally to the body 6 of the grinder 5 whereas the flange portion 34 is located distally to the body 6 of the grinder 5.

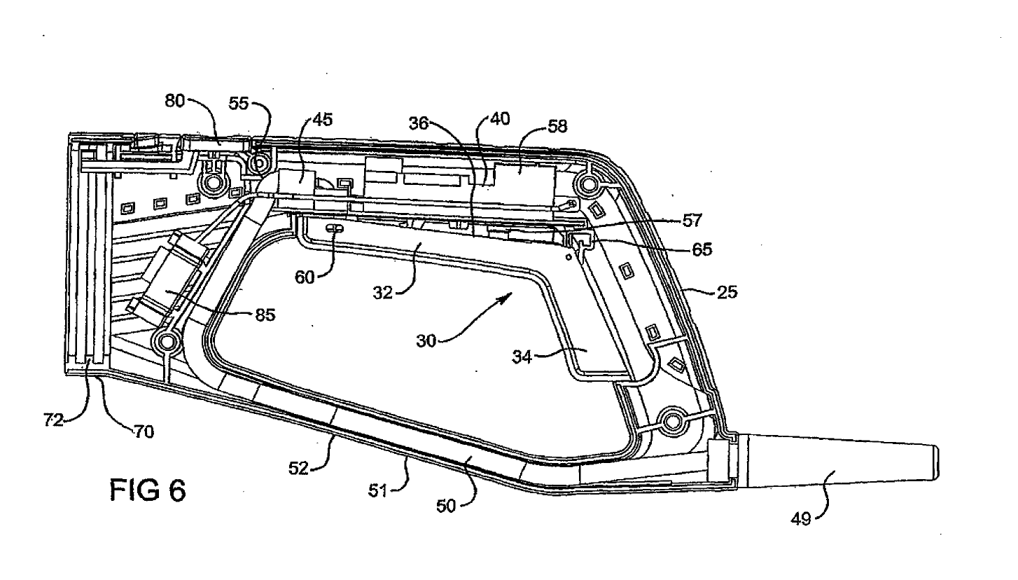

As is shown in detail in FIG. 6 the trigger 30 is coupled to the switch 40. The switch 40 includes a power cord receiving portion 45 that receives an end 55 of a power cord 50. The other end (not shown) of the power cord 50 is connected to a power supply (not shown). Power is supplied by the power cord 50 to the power cord receiving portion 45 which is electrically connected to an electrode 57 located on an upper surface 36 of the elongate portion 32 of the trigger 30. The switch 40 also includes an electrode receiver 58 that is electrically connected to the grinder 5. When the electrode 57 and electrode receiver 58 are brought into engagement this enables current to flow from the power supply through the power cord 50 and the switch 40 and on to activate the grinder 5. At a point 60 on the elongate portion 32 of the trigger 30, which is distal from the flange portion 34 and proximal to the body 6 of the grinder 5, the elongate portion 32 of the trigger 30 is pivotally attached to the first handle portion 20. The flange portion 34 and the elongate portion 32 of the trigger 30 pivot in an arc of motion about the pivot point 60 between a position in which the electrode 57 and the electrode receiver 58 are in engagement and a position in which they are disengaged.

In addition, the trigger 30 further includes a safety means 65 for avoiding inadvertent engagement of the electrode 57 and the electrode receiver 58. The safety means 65 includes a guide for the movement of the trigger 30 such that for the trigger 30 to pivot in the arc of motion about the pivot point 60 between a position in which the electrode 57 and the electrode receiver 58 are in engagement and a position in which they are disengaged the trigger 30 must first be slid from an initial, default position as shown in FIG. 6, substantially longitudinally in a direction away from the pivotal attachment 60 of the elongate portion 32 and towards the flange portion 34 of the trigger 30. To enable this action the guide includes a first elongate slot (not shown) provided on any one or more of the first handle portion 20, the second handle portion 25, the flange portion 34 or the elongate portion 32 of the trigger 30. The first elongate slot is oriented longitudinally in a direction from the grinder body 6 and towards the second handle portion 25. The first elongate slot receives a protrusion (not shown) attached to any one or more of either the first handle portion 20, the second handle portion 25, the flange portion 34 or the elongate portion 32 of the trigger 30 such that the protrusion slides longitudinally relative to the first elongate slot and in turn the trigger 30 slides longitudinally relative to the first handle portion 20 and the second handle portion 25.

The guide also includes a second elongate slot (not shown) provided on any one or more of the first handle portion 20, the second handle portion 25, the flange portion 34 or the elongate portion 32 of the trigger 30. When the trigger 30 has slid a predetermined longitudinal distance in a direction away from the pivotal attachment 60 of the elongate portion 32 and towards the flange portion 34 of the trigger 30, the protrusion reaches the second elongate slot which may be provided on the same, or another one or more of the first handle portion 20, the second handle portion 25, the flange portion 34 or the elongate portion 32 of the trigger 30 onto which is provided the first elongate slot. The second elongate slot is oriented in a direction substantially transverse to the first handle portion 20. The protrusion in the second elongate slot slides longitudinally relative to the protrusion in the second elongate slot and in turn the trigger 30 slides longitudinally relative to the first handle portion 20 and the second handle portion 25 in a direction substantially transverse to the first handle portion 20.

Accordingly, the safety means 65 provides the switch and handle assembly 10 with a two stage action involving, firstly a slide action of the trigger 30 away from the grinder body 6 and towards the second handle portion 25, and then secondly, a pivoting action towards and into the first handle portion 20 where the electrode 57 and electrode receiver 58 are brought into engagement. This enables current to flow from the power supply through the power cord 50 and the switch 40 and on to activate the grinder 5. When the user releases the trigger 30 a biasing means (not shown) biases the trigger 30 in the reverse direction through the second and first elongate slots back to the initial, default position shown in FIG. 6.

An advantage of the present invention is that the flange portion 34 and the elongate portion 32 of the trigger 30 are associated with the first handle portion 20 and the second handle portion 25 respectively. This enables a user to hold the grinder 5 by gripping either the first handle portion 20 or the second handle portion 25 and yet be able to operate the trigger 30 through the two stage action of the guide by firstly moving the trigger 30 away from the grinder body 6 and towards the second handle portion 25, and then secondly, pivoting the trigger towards and into the first handle portion 20 where the electrode 57 and electrode receiver 58 so as to actuate the switch 40 that operates the power tool 5. As will be appreciated this unique arrangement enables a user to apply force to the first handle portion 20 and the second handle portion 25 of the handle assembly 10, and in turn apply force to the grinder 5 and the working element 2, in different directions and in greater magnitudes, with greater ease of use and while still providing an accessible trigger 30 for activating the grinder 5, than has been possible with previous handle and switch assemblies.

As is shown in FIGS. 1 to 6, another preferable feature of the invention is a guard 52 that is integral with both the second handle portion 25 and the grinder body 6 so as to provide a connection between the second handle portion 25 and the grinder body 6. The guard 52 provides, together with the first handle portion 20 or the second handle portion 25, a continuous loop around the trigger 30 that protects the trigger 30 from damage if the grinder 5 is inadvertently dropped. The guard 52 can also reduce the likelihood of the trigger 30, and in turn the grinder 5, from being activated through inadvertent contact with the trigger 30. The inclusion of a guard 52 also enables a power cord 50, which at one end (not shown) is connectable to a power source (not shown), to be coupled to the grinder 5 in the vicinity of the lower end of the second handle portion 25 towards the guard 52 and to be located in a passage 51 within the guard and to ultimately reach the power cord receiving portion 45 which is located in the vicinity of the pivotal connection 60 of the trigger 30. This arrangement is advantageous in that the portion 49 of the power cord 50 adjacent to and outside the guard 52 does not impede a user from gripping either the first handle portion 20 or the second handle portion 25. In other words, both the first handle portion 20 and the second handle portion 25, in the region of the trigger 30, are free of a protruding and impeding portion 49 of the power cord 50.

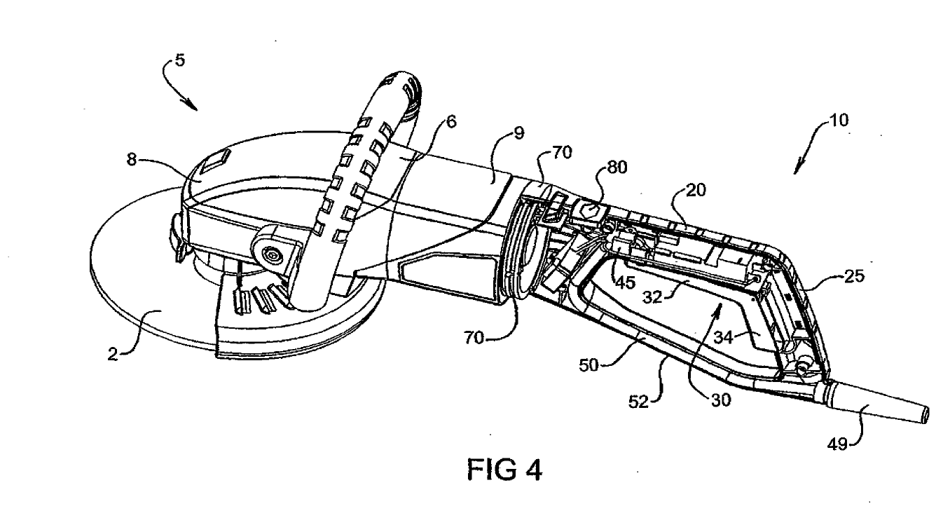

The handle assembly 10 of the present invention is preferably pivotally mounted to the body 6 of the hand held power tool 5. This is enabled by providing a circular sleeve 70 on the handle assembly 10 that mounts to a short cylindrical portion 75 extending longitudinally from the body 6 of the grinder 5. FIG. 4 shows the short cylindrical portion 75 and a cut away view of the circular sleeve 70 on the handle assembly 10. As is best shown in FIG. 6, ridges 72 about the inner circumference of the sleeve 70 cooperate with ridges 77, which are most clearly shown in FIG. 4, about the outer circumference of the cylindrical portion 75 to retain the handle assembly 10 to the body 6 of the grinder 5 yet enable relative rotation there-between. Accordingly, this form of pivotal mounting of the handle assembly 10 to the grinder 5 allows the handle assembly 10 to rotate relative to the grinder 5. This form of the invention enables a user operating the grinder 5 to adjust the handle assembly 10 to a desired orientation that offers a secure and comfortable grip for the user. In FIGS. 1 to 5 only show one relative orientation of the handle assembly 10, where the second handle portion 25 is oriented in a downward direction from the first 20 handle. However, the handle assembly 10 can rotatably pivot through 360 degrees relative to the grinder 5. For example, if the handle assembly 10 were rotated 90 degrees relative to the grinder 5 the second handle portion 25 would extend in a sideways direction from the first handle portion 20.

A detent 80 is provided adjacent to the circular sleeve 70 on the handle assembly 10. The detent 80 releasably engages the short cylindrical portion 75 extending longitudinally from the body 6 of the grinder 5 to retain the handle assembly 10 in a desired orientation and to release the handle assembly 10 to pivot to another desired orientation. However, other suitable means for releasably retaining the handle assembly 10 in a desired orientation may be used.

In another particularly preferred form, the handle assembly 10 also includes, as is particularly shown in FIG. 6, a soft start control module 85 for controlling power supplied to the grinder 5 when the electrode 57 and electrode receiver 58 are brought into engagement enabling current to flow from a power supply through the power cord 50 and the switch 40 and on to the grinder 5.

Another preferred feature of the invention that is not shown in the Figures is a releasable trigger locking means that enables a user to lock the trigger 30 in the position where the electrode 57 and electrode receiver 58 are brought into engagement to activate the grinder 5. The user can activate the grinder 5 by initially moving the trigger 30 by hand through the two stage action of the guide by firstly moving the trigger 30 away from the grinder body 6 and towards the second handle portion 25, and then secondly by pivoting the trigger towards and into the first handle portion 20 and then, by locking the trigger 30, proceed to use the grinder 5 for extended periods without having to retain the trigger 30 in position by hand. When the user wants to deactivate the grinder 5 the user releases the trigger locking means so that the trigger returns to its original position in which the electrode 57 and electrode receiver 58 are disengaged.

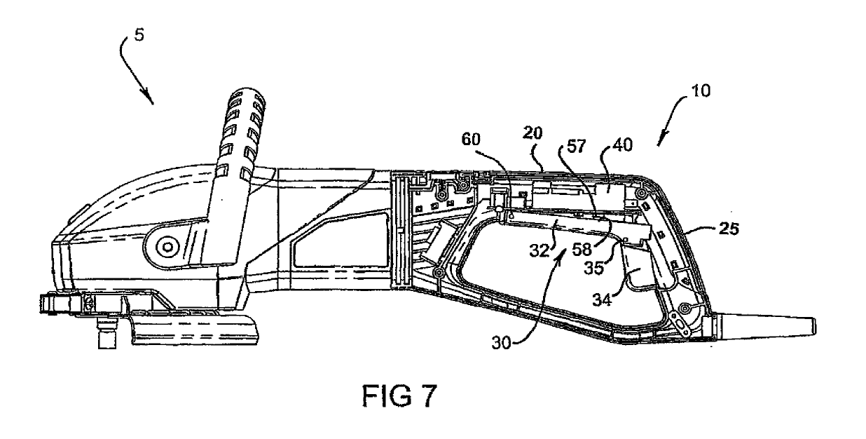

In FIGS. 7 to 10 there is shown a handle assembly 10 for mounting to a hand held power tool 5 in accordance with another preferred form of the invention. The handle assembly 10 of FIGS. 7 to 10 is substantially the same as that of FIGS. 1 to 6 with the exception of the arrangement of the trigger 30. However, this preferred form of the invention still requires the user to manipulate the trigger 30 in two substantially transverse directions.

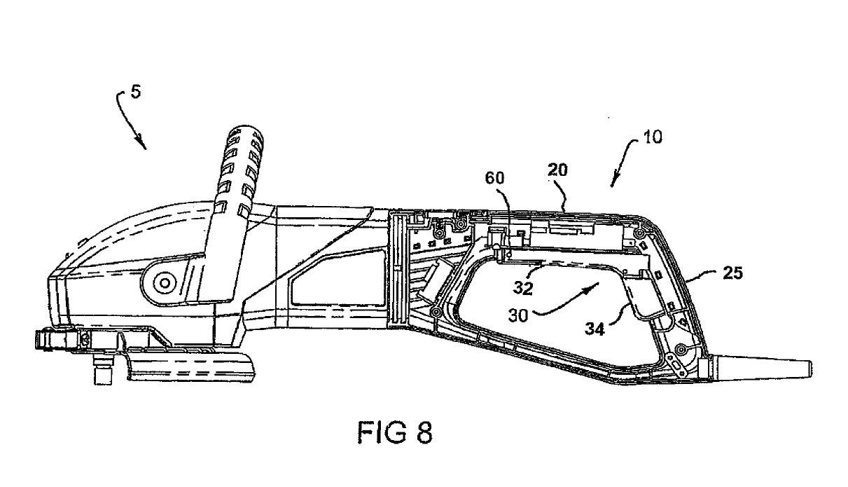

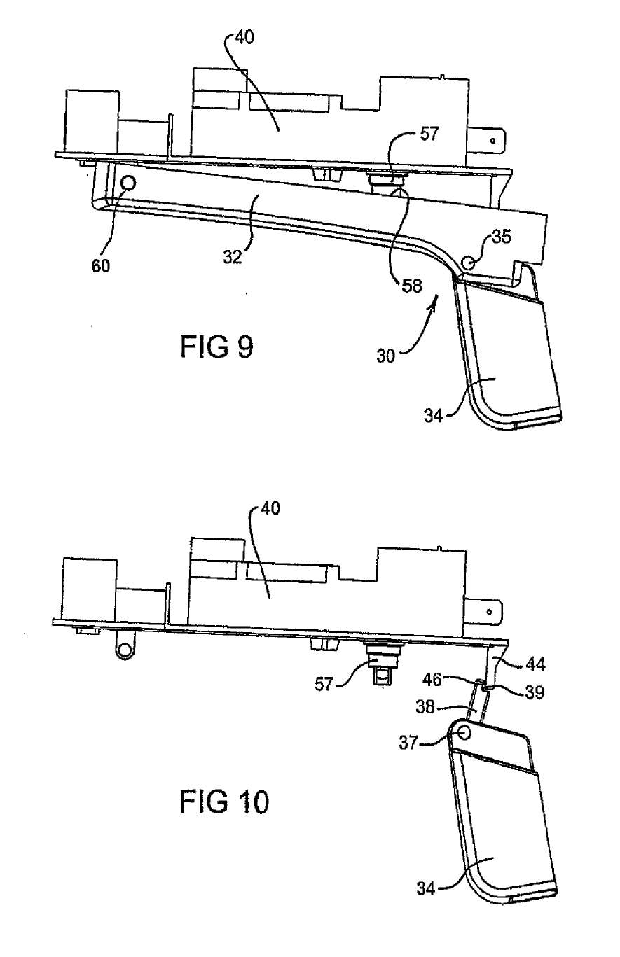

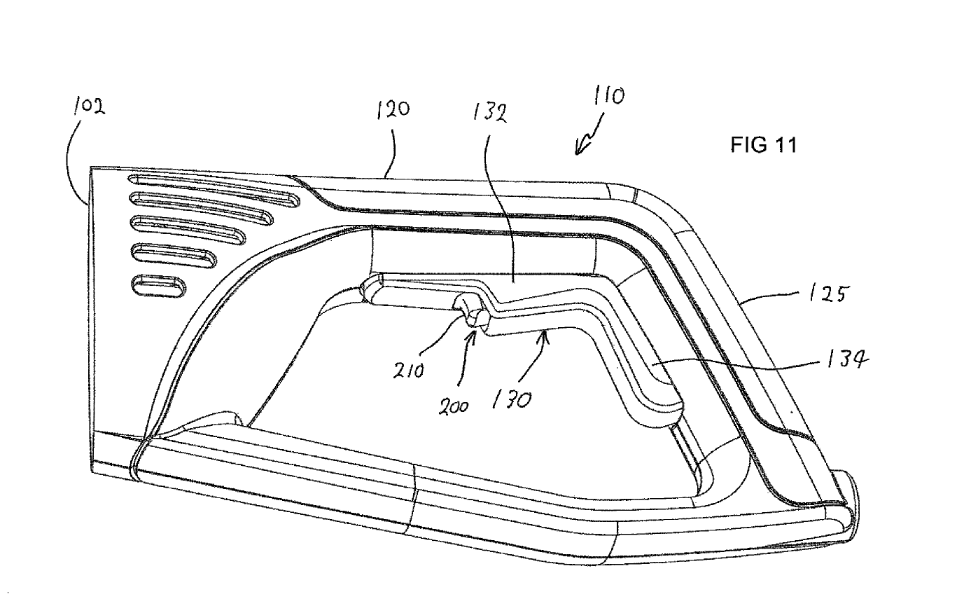

As can be seen generally in FIGS. 7 and 8 and, particularly in FIGS. 9 and 10, in this embodiment the elongate portion 32 and the flange portion 34 of the trigger 30 are pivotally interconnected at a trigger pivot point 35. This pivotal interconnection can be achieved by various suitable means including by providing aperture 36 (see FIG. 9) and aperture 37 (see FIG. 10), through the elongate portion 32 and the flange portion 34 at the trigger pivot point 35 and interconnecting the elongate portion 32 and the flange portion 34 by fixing a rod (not shown) within the apertures about which the elongate portion 32 and the flange portion 34 pivot.

In FIGS. 7 to 10 the elongate portion 32 of the trigger 30 has the electrode receiver 58 located on its upper surface 36 and the switch 40 has the electrode 57 protruding downwardly therefrom. The flange portion 34 and the elongate portion 32 of the trigger 30 pivot in an arc of motion about the pivot point 60 between a position in which the electrode 57 and the electrode receiver 58 are in engagement and the grinder 5 is activated, shown in FIG. 8, and a position in which they are disengaged and the grinder 5 is deactivated, shown in FIG. 7. The latter, that is where the elongate portion 32 and the flange portion 34 of the trigger 30 are in a position such that the electrode 57 and the electrode receiver 58 are disengaged and the grinder 5 is deactivated, as shown in FIG. 7, is the default position of the trigger 30.

As can be seen in FIG. 10, a projection 38 from the flange portion 34 has an abutting surface 39 that abuts against an abutting surface 46 of a projection 44 from the switch 40 when the flange portion 34 is in the position illustrated in FIGS. 7, 9 and 10 corresponding to when the trigger is in the default position. When the user wishes to activate the grinder 5 the user may grip the either the first handle portion 20 or the second handle portion 25 and depress the flange portion 34 and then depress the elongate portion 32. Directly depressing the elongate portion 32 of the trigger 30 alone will not cause the electrode 57 to engage the electrode receiver 58 as the abutting surfaces 39, 46 prevent this. Instead the user must depress the flange portion 34 first by gripping either the first handle portion 20 or the second handle portion 25 and pivoting the flange portion 34 about the pivot point 35. When, as is shown in FIG. 8, a user depresses the flange portion 34 it pivots about the abutting surfaces 39, 45 of the projections and, simultaneously, the flange portion 34 pivots relative to the elongate portion 32 about the trigger pivot point 35. This causes the projection 38 to move towards the pivot point 60 of the elongate portion 32 such that the abutting surface 39 of the projection 38 moves out of abutment with, or disengages from, the abutting surface 46 of the projection 44. Once this disengagement has occurred the projections 38, 44 can slide relative to each other and the elongate portion 32 can be depressed by pivoting the elongate portion 32 about the pivot point 60 to cause the electrode 57 to engage the electrode receiver 58 and, in turn, activate the grinder 5. This arrangement of the handle assembly 10 is also useful for avoid inadvertent engagement of the electrode 57 and the electrode receiver 58.

The above embodiments of the handle assembly 10, when applied to a power tool such as the grinder 5, results in the angle grinder satisfying the safety requirements of the trigger 30 to be manipulated in two substantially transverse directions to cause operation of the grinder 5 or other power tool having such safety requirements. When the user releases the trigger 30 the biasing means (not shown) biases the trigger 30 to the initial, default position shown in FIGS. 7, 9 and 10.

An alternative form of the handle assembly 10, may include an arrangement of the trigger 30 such that the elongate portion 32 and the flange portion 34 are movable independently of each other. In one form, the elongate portion 32 may be depressable inwardly to the first handle portion 20 while the flange portion 34 remains stationary. Conversely, the flange portion 34 may be depressable inwardly to the second handle portion 20 while the elongate portion 32 remains stationary. In such forms of the invention, the switch 40 for operating the power tool 5 is still actuated by movement of either the elongate portion 32 or the flange portion 34 of the trigger 30 relative to the first handle portion 20 or second handle portion 25 respectively. There may also be more than one switch 40, one switch 40 being associated with the elongate portion 32 and one switch 40 associated with the flange portion 34. In yet another form, the handle assembly 10, or a power tool 5 incorporating the handle assembly 10, may include a secondary switch (not shown) for operating the power tool 5 when the switch 40 is actuated by movement of either the elongate portion 34 or the flange portion 34 of the trigger 30 relative to the first handle portion 20 or the second handle portion 25 respectively.

Referring to FIGS. 11 to 13 there is shown another embodiment of a handle assembly 110 in accordance with the invention. The handle assembly 110 is adapted for mounting to a hand held power tool (not shown in FIGS. 11 to 13) such as the hand held power grinder 5 illustrated in FIGS. 1 to 5, 7 and 8 or any other suitable hand held power tool. The handle assembly 110 includes a first handle portion 120 and a second handle portion 125. The first and second handle portions 120, 125 are integral and are mountable to the power tool. The handle portions 120, 125 are for gripping the power tool. The first handle portion 120 extends substantially transverse to the second handle portion 125. Also included is a trigger 130 mounted to the handle portions 120, 125.

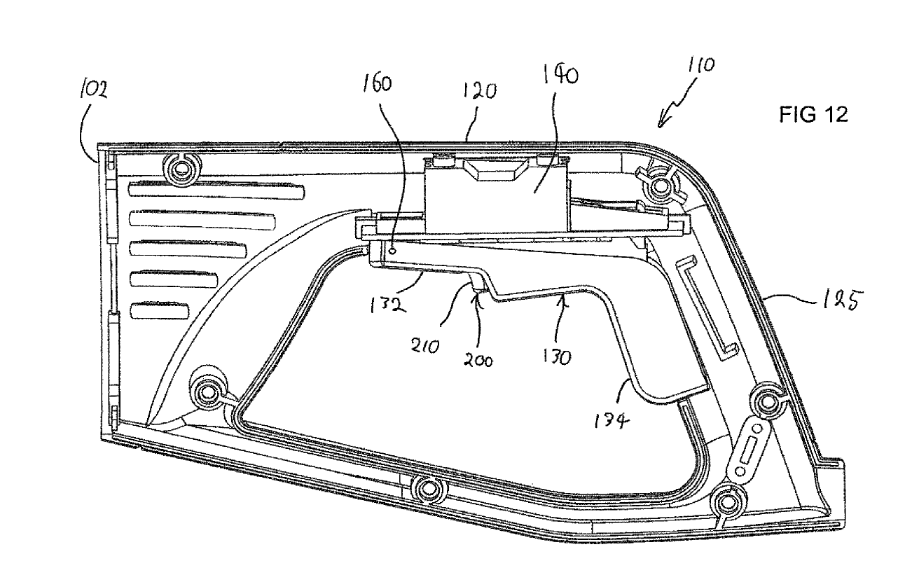

As shown in FIG. 12, the trigger 130 is also coupled to a switch 140 which is alike in functionality to the switch 40 of the embodiments illustrated in FIGS. 1 to 10. The switch 140 facilitates operation of the power tool by enabling the activation and deactivation of the power tool. The trigger 130 acts as a means by which a user can actuate the switch 140 to operate the power tool. The trigger 130 includes an elongate portion 132 associated with the first handle portion 120 and a flange portion 134 associated with the second handle portion 125 and oriented substantially transversely to the elongate portion 132. This enables a user, while gripping either handle portion 120, 125, to operate the trigger 130 and in turn actuate the switch 140 that operates the power tool.

As in the embodiments of FIGS. 1 to 10, the trigger 130 of the handle assembly 110 is pivotally attached at a point 160 on the elongate portion 132 of the trigger 130, which is distal from the flange portion 134 and proximal to a front end 102 of the handle assembly 110 which is adapted to be mounted to the power tool. Accordingly, the entire trigger 130 is pivotally attached to the first handle portion 120 at the pivotal attachment point 160. The flange portion 134 and the elongate portion 132 of the trigger 130 thereby pivot in an arc of motion about the pivotal attachment point 160 towards and away from the first handle portion 120 which correspond to positions in which the switch 140 is actuated to activate and deactivate the power tool respectively. In other words, the pivotal attachment of the trigger 130 to the first handle portion 120 enables a user to depress the trigger 130 to thereby activate the power tool and to release the trigger 130 which is biased away from the depressed position to thereby deactivate the power tool.

In addition, as illustrated in FIGS. 11 to 13, the handle assembly 110 further includes a trigger release mechanism 200 for selectively enabling movement of the trigger 130 relative to the first or second handle portions 120, 125 and thereby avoiding inadvertent depression of the trigger 130 in the manner described above. Accordingly, the trigger release mechanism 200 avoids inadvertent activation of the power tool. The trigger release mechanism 200 includes a trigger release button 210 which is mounted to the elongate portion 132 of the trigger 130 but it could be mounted to the flange portion 134 of the trigger 130. The trigger release button 210 is positioned on the trigger 130 so that when a user grips either the first or second handle portion 120, 125 and also grips the trigger 130 the user can depress the trigger release button 210 from a first position to a second position by pushing the trigger release button 210 into the trigger 130. Depressing the trigger release button 210 operates to release the trigger 130 from a locked state so that the trigger 130 can be depressed to thereby activate the power tool 5. The trigger release button 210 may operate to lock the trigger 130 and to release the trigger 130 from its locked state by any suitable means. The trigger release button 210 is biased to the first position from the second position.

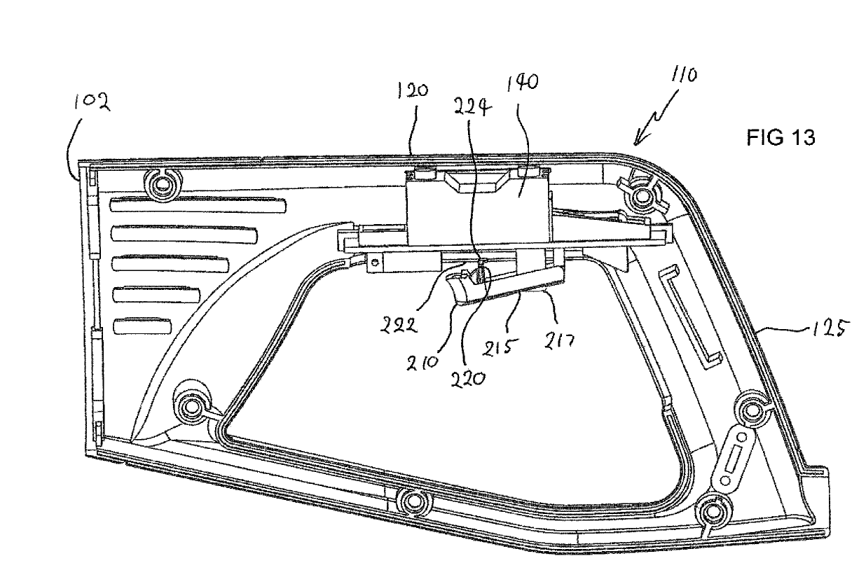

In FIG. 12 and particularly FIG. 13, the trigger release mechanism 200 is illustrated in more detail. The trigger release button 210 of the trigger release mechanism 200 includes an elongate opening 215 which receives a boss 217 projecting from the first handle portion 120 therethrough. The elongate opening 215 of the trigger release button 210 is adapted to slide back and forth relative to the boss 217 so that the trigger release button 210 may also slide back and forth relative to the boss 217. When the trigger release button 210 is depressed as described above the button 210 slides back towards the second handle portion 125 and a projection 220 extending from the button 210 towards the first handle portion 120 moves from a position (not shown) in abutment with an abutment surface 222 of the first handle portion 120 to a position shown in FIG. 13 in alignment with an aperture 224 within the abutment surface 222. When the projection 220 extending from the button 210 is in abutment with the abutment surface 222 the button may not move towards the first handle portion 120 which in turn prevents the trigger 130 from pivoting about the pivotal attachment point 160 towards the first handle portion 120 and thereby prevents the trigger 130 from being depressed and in turn prevents inadvertent activation of the power tool. Conversely, when the projection 220 extending from the button 210 is in alignment with the aperture 224 within the abutment surface 222 the projection 220 can move into the aperture 224 such that the button may move towards the first handle portion 120 which in turn enables the trigger 130 to pivot about the pivotal attachment point 160 towards the first handle portion 120 and thereby enable the trigger 130 to be depressed and in turn enables activation of the power tool.

The trigger release mechanism 200 is advantageous in that it enhances the safety of the handle assembly 110 by providing a means for avoiding inadvertent depression of the trigger 130 and, therefore, inadvertent activation of the power tool. Accordingly, trigger release mechanism 200 provides the switch and handle assembly 110 with a two stage action involving, firstly a depression action of the trigger release button 210 and then secondly a pivoting action of the trigger 130 towards and into the first handle portion 120 where the switch 140 is actuated to activate the power tool.

Finally it is to be understood that various alterations, modifications and/or additions may be introduced to the parts previously described without departing from the spirit or ambit of the invention.

1. A handle assembly for a hand held power tool including:
first and second handle portions for gripping the power tool, the first handle portion extending substantially transverse to the second handle portion;
a trigger including an elongate portion associated with the first handle portion and a flange portion associated with the second handle portion; and
a switch for operating the power tool actuated by movement of either the elongate or flange portion of the trigger relative to the first or second handle portions respectively.

2. The handle assembly according to claim 1, wherein one end of the elongate portion is movably mounted to the first handle portion and an opposite end of the elongate portion is pivotally interconnected with the flange portion.

3. The handle assembly according to claim 1, wherein one end of the elongate portion is movably mounted to the first handle portion and an opposite end of the elongate portion is integrally formed with the flange portion.

4. The handle assembly according to claim 1, wherein the elongate portion and the flange portion are movable independently of each other.

5. The handle assembly according to claim 1, wherein the one end of the elongate portion is pivotally mounted to the first handle portion such that the elongate portion and the flange portion of the trigger pivot in an arc of motion for actuating the switch.

6. The handle assembly according to claim 1, further including a guard that is integral with one or more of the handle portions and is configured to form, together with the handle portions, a continuous loop around the trigger.

7. The handle assembly according to claim 6, further including an electric power lead for supplying electric current from a power source to the power tool, wherein the power lead has two ends, one end is connectable to the power source and the other end is coupled to the guard.

8. The handle assembly according to claim 1, wherein the switch has two parts, one part of the switch is integral with the elongate portion of the trigger and the other part of the switch is integral with the first handle portion such that movement of the trigger includes moving the elongate portion of the trigger towards the first handle portion for actuating the switch by engaging the two parts of the switch together.

9. The handle assembly according to claim 1, wherein the trigger is attached to the first and second handle portions such that movement of the trigger to actuate the switch to operate the power tool involves sliding the trigger substantially longitudinally towards the second handle portion.

10. The handle assembly according to claim 1, further including biasing means for biasing the trigger relative to the first and second handles to a default position in which the switch does not operate the power tool.

11. The handle assembly according to claim 1, further including a releasable trigger lock for releasably locking the trigger relative to the first and second handles in a position in which the switch operates the power tool.

12. The handle assembly according to claim 1, wherein the handle assembly is pivotally mountable to the hand held power tool for enabling the handle assembly to pivot between various orientations relative to the hand held power tool.

13. The handle assembly according to claim 12, wherein the handle assembly is pivotable relative to an axis of the power tool through 360 degrees.

14. The handle assembly according to claim 12, wherein the handle assembly is pivotable relative to an axis of the power tool through between 0 and 180 degrees.

15. The handle assembly according to claim 12, further including means for releasably retaining the handle assembly in the various orientations.

16. The handle assembly according to claim 1, wherein the power tool is a hand held power angle grinder.

17. The handle assembly according to claim 1, further including a secondary switch for operating the power tool when the switch actuated by movement of either the elongate or flange portions of the trigger relative to the first or second handle portions respectively has been actuated.

18. The handle assembly according to claim 1, wherein the assembly includes a soft start control module for controlling power to the power tool.

19. The handle assembly according to claim 1, wherein the assembly includes an overload protection device.

20. The handle assembly of claim 1, further including a trigger release mechanism which selectively enables movement of the trigger relative to the first or second handle portions.

21. The handle assembly of claim 20, wherein the trigger release mechanism includes a trigger release button which is mounted to the trigger and in a first position prevents relative movement of the trigger relative to the first or second handle portions and in a second position enables the trigger to move relative to the first or second handle portions.

22. The handle assembly of claim 21, wherein the trigger release button is normally in the first position and can be depressed by a user to the second position.

23. A power tool having a handle assembly including:
first and second handle portions for gripping the power tool, the first handle portion extending substantially transverse to the second handle portion;
a trigger including an elongate portion associated with the first handle portion and a flange portion associated with the second handle portion; and
a switch for operating the power tool actuated by movement of either the elongate or flange portion of the trigger relative to the first or second handle portions respectively.

24. The power tool of claim 23, wherein the power tool is an angle grinder.
